(19) United States
(12) Patent Application Publication
(10) Pub. No.: US 2007/0223466 A1
(43) Pub. Date: Sep. 27, 2007

(54) Control system and instrument

(75) Inventors: Masahiro Takeshita, Daito-shi (JP); Yasuo Masaki, Daito-shi (JP); Yasunari Miyake, Daito-shi (JP); Hideki Tanabe, Daito-shi (JP); Sadanori Murakami, Daito-shi (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/728,642

(22) Filed: Mar. 27, 2007

(30) Foreign Application Priority Data
Mar. 27, 2006 (JP) 2006-085586

(51) Int. Cl. H04L 12/50

(52) U.S. Cl. 370/360

(57) ABSTRACT

There is provided a control system capable of being installed easily and controlling rapidly and sufficiently. The control system includes a remote controller and a plurality of remote-control adapters. The remote controller includes a light-emitting unit performing signal communication. The remote-control adapter includes a reception unit and a processing unit. The reception unit receives a control signal from the light-emitting unit of the remote controller. When the reception unit receives a broadcast signal as a kind of control signal, the processing unit performs an action according to a combination of the broadcast signal and the remote-control adapter.

### BACKGROUND OF THE INVENTION

1. Field of the Invention

The present invention relates to a control system and an instrument, particularly to a control system and instrument for synchronous operation.

2. Description of the Background Art

Japanese Patent Laying-Open No. 2004-179862 discloses a portable telephone including a first memory, a selection circuit, a second memory, and a control circuit. The first memory stores a plurality of communication protocols. The selection circuit selects one communication protocol from the first memory. The second memory retains information on the selected particular communication protocol. When a talk is started using the portable telephone, the control circuit automatically controls an operating status of a household electric appliance with an infrared ray transmitted pursuant to the selected communication protocol.

According to the invention disclosed in Japanese Patent Laying-Open No. 2004-179862, when a telephone call is placed or received while a television is turned on at full blast, an electronic product can automatically be operated such that the television is automatically muted or a video is recorded.

Japanese Patent Laying-Open No. 2000-175275 discloses a control apparatus for controlling instruments connected to a network. The control apparatus includes a first determination circuit, a second determination circuit, a third determination circuit, and a switching circuit. The first determination circuit determines whether or not the control apparatus transits between predetermined states. When the first determination circuit determines that the control apparatus is in the predetermined state, the second determination circuit determines whether or not each of the instruments connected to the network has a muting function. The third determination circuit determines a current state of the control apparatus. The switching circuit switches whether or not to enable the muting function to the instrument having the muting function according to the state determined by the third determination circuit.

According to the invention disclosed in Japanese Patent Laying-Open No. 2000-175275, each instrument connected to a bus can be controlled to achieve a desired object such as calming in a house without manually remotely operating the instrument.

Japanese Patent Laying-Open No. 04-023348 discloses a telephone having a remote-control function. The telephone includes a selection unit, a setting unit, a distinction unit, and a control unit. The selection unit selects at least a learning mode and a transmission mode. In the learning mode, the setting unit sets remote-control data in a memory according to a state of the telephone. In the transmission mode of the remote-control data, the distinction unit distinguishes the state of the telephone. The control unit transmits the remote-control data according to the state of the telephone.

According to the invention disclosed in Japanese Patent Laying-Open No. 04-023348, a user can set an audio instrument and an AV (Audio-Video) instrument to a desired state so as not to fail to hear a ringing tone of a telephone and not to perform a remote-control operation every time a telephone call is received.

However, according to the inventions disclosed in Japanese Patent Laying-Open No. 2004-179862 and Japanese Patent Laying-Open No. 04-023348, there is a problem that it takes a long time to control the instrument. For example, in the telephones according to the invention disclosed in Japanese Patent Laying-Open No. 2004-179862 and Japanese Patent Laying-Open No. 04-023348, when a telephone bell rings during watching a television, recording is started after a television is muted, or the television is muted after the recording is started. Usually about 0.1 second is required for communication to each instrument. Therefore, in such a case as in these examples where many instruments are controlled, an important scene which the user fails to watch may not be recorded, or the volume of the television may not be turned down although a telephone talk is started.

According to the invention disclosed in Japanese Patent Laying-Open No. 2000-175275, there is a problem that a desired object such as calming in a house cannot be achieved unless an instrument is connected to the bus.

### SUMMARY OF THE INVENTION

The present invention is made to solve the above-described problems and an object of the invention is to provide a control system and instrument capable of being installed easily and controlling rapidly and sufficiently.

In brief, in order to solve the above-described problems, a control system according to an aspect of the invention includes a remote controller and a plurality of remote-control adapters. The remote controller includes a communication unit performing signal communication so as to transmit a broadcast signal as a kind of control signal to the plurality of remote-control adapters until receiving an off-hook signal since receiving a ringing signal. The remote-control adapter includes a reception unit receiving the broadcast signal from the communication unit of the remote controller; and a performing unit performing an action according to a combination of the broadcast signal and the remote-control adapter when the reception unit receives the broadcast signal.

A control system according to another aspect of the invention includes a communication apparatus and a plurality of instruments. The communication apparatus includes a communication unit performing signal communication. The instrument includes a reception unit receiving a control signal from the communication unit of the communication apparatus; and a performing unit performing an action according to a combination of the broadcast signal and the instrument when the reception unit receives a broadcast signal as a kind of control signal.

Preferably, the communication unit of the communication apparatus performs signal communication so as to transmit the broadcast signal to the plurality of instruments when receiving the ringing signal.

Preferably, the communication unit performs signal communication so as to transmit the broadcast signal to the plurality of instruments until receiving an off-hook signal since receiving a ringing signal.

Preferably, the communication apparatus further includes an operation unit accepting an operation to the communication apparatus. The communication unit of the communication apparatus transmits the control signal corresponding to contents of the operation to the plurality of instruments when the operation is accepted.

An instrument according to still another aspect of the invention includes a reception unit receiving a control signal; a storage unit storing information indicating contents of the control signal such that at least a part of contents of a broadcast signal as a king of control signal overlaps one of the contents of the control signal; a generation unit generating the control signal corresponding to the information stored in the storage unit when the reception unit receives the control signal; and a transmission unit transmitting the control signal generated by the generation unit using an infrared ray.

Preferably, the reception unit receives the control signal through wireless communication.

Preferably, the reception unit receives the control signal through communication using the infrared ray.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a room in which electronic instruments equipped with remote-control adapters are arranged;

FIG. 2 shows a mode in which a remote-control adapter is attached to a television;

FIG. 3 is a block diagram showing a functional configuration of the remote-control adapter;

FIG. 4 is a block diagram showing a hardware configuration of the remote-control adapter;

FIG. 5 shows a mode in which data is stored in a flash memory;

FIG. 6 is a flowchart showing a procedure of a process performed by a control circuit;

FIG. 7 conceptually shows a configuration of an optical ID signal;

FIG. 8 shows an appearance of a remote controller;

FIG. 9 is a block diagram showing a hardware configuration of the remote controller;

FIG. 10 is a block diagram showing a specific configuration of a drive circuit;

FIG. 11 is a block diagram showing a functional configuration of the control circuit;

FIG. 12 shows data stored in a memory when the remote controller authenticates an air conditioner as a control target;

FIG. 13 is a flowchart showing a procedure of a process performed to authenticate a controlled instrument by the control circuit;

FIG. 14 shows an image displayed on a display when the remote controller performs a process of authenticating the air conditioner;

FIG. 15 conceptually shows data stored in the memory of the remote controller after the remote controller authenticates an HDD recorder;

FIG. 16 is a flowchart showing a procedure of a process performed to authenticate another controlled instrument by the remote controller which has already authenticated the controlled instrument;

FIG. 17 shows an image displayed when the remote controller authenticates the HDD recorder;

FIG. 18 is a flowchart showing a procedure of a process performed to control the controlled instrument by the remote controller;

FIG. 19 shows an image displayed when the remote controller does not authenticate the controlled instrument;

FIG. 20 shows an image displayed when the remote controller authenticates the controlled instrument;

FIG. 21 shows a format of a remote-control code transmitted by the remote controller;

FIG. 22 is a flowchart showing a procedure of a broadcast command performing process;

FIG. 23 is a flowchart showing a procedure operated by the remote controller when a telephone call is received; and

FIG. 24 is a flowchart showing a procedure of operation by the remote-control adapter when the telephone call is received.

### DESCRIPTION OF THE PREFERRED EMBODIMENTS

A preferred embodiment of the invention will be described with reference to the drawings. In the following description, the same component is designated by the same numeral, and the same component has the same name and the same function. Therefore, the same component is not repeatedly described in detail.

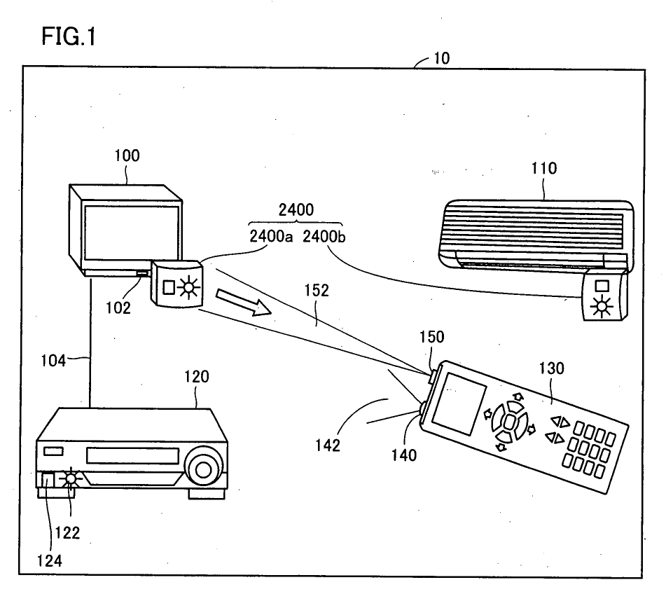

Referring to FIG. 1, a usage mode of a control system according to an embodiment of the invention will be described below. FIG. 1 shows a room 10 in which electronic instruments equipped with remote-control adapters 2400 are arranged.

A television 100, an HDD recorder 120, and an air conditioner 110 are arranged in room 10. Television 100 and HDD recorder 120 are connected through a cable 104. A remote-control adapter 2400a is attached to a front panel of television 100. Similarly a remote-control adapter 2400b is attached to a front face of air conditioner 110. Remote-control adapters 2400a and 2400b are generically referred to as remote-control adapter 2400. Remote-control adapter 2400a transmits an optical signal including identification information for identifying remote-control adapter 2400a in the form of blinking light 152.

A remote controller 130 is also arranged in room 10. Remote controller 130 includes a light-emitting unit 140 and a camera 150. Light-emitting unit 140 outputs a signal for controlling an action of the electronic instrument, and camera 150 images a subject to obtain a video signal. Light-emitting unit 140 irradiates the electronic instrument with a remote-control signal 142 according to a predetermined angle. For example, an infrared ray is used as remote-control signal 142.

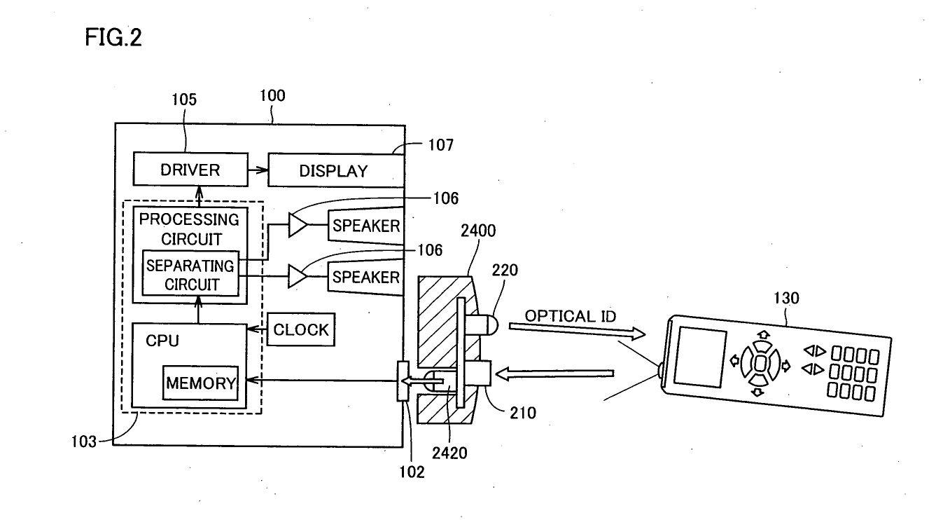

Referring to FIG. 2, a mode in which remote-control adapter 2400 of the embodiment is attached will be described. FIG. 2 shows a mode in which remote-control adapter 2400 is attached to television 100.

Remote-control adapter 2400 is attached to television 100 by an attaching member (not shown) such as adhesion tape and detachable cloth tape such that a control signal transmission unit 2420 and a remote-control light-acceptance unit 102 face each other. A control signal transmitted from control signal transmission unit 2420 is received by remote-control light-acceptance unit 102.

Remote-control adapter 2400 includes a reception unit 210 and a transmission unit 220. Reception unit 210 receives an ID request signal for requesting ID (Identification) of remote-control adapter 2400 from the outside, and transmission unit 220 transmits an ID signal in response to the request.

Light-acceptance unit 102 is arranged in a front face (i.e., the same face as the face in which a display 107 is arranged) of television 100 to receive the control signal transmitted from remote controller 130. Television 100 also includes display 107, a control circuit 103, a driver 105, and an amplifier 106. Display 107 displays the video image. Control circuit 103 controls the action of television 100 based on the control signal received by light-acceptance unit 102. Driver 105 transmits the video signal to display 107 to realize the display of the video image based on the signal obtained from the control circuit 103. Amplifier 106 amplifies an audio signal obtained from control circuit 103. Control circuit 103 provides a channel select command to a tuner (not shown) when the control signal includes a channel select instruction. When control signal includes an instruction for turning down the volume or an instruction for turning up the volume, control circuit 103 provides a command for strengthening the audio signal or a command for weakening the audio signal to amplifier 106 based on the instruction. The action of television 100 is well known, and therefore the detailed description is repeated.

The attaching mode of remote-control adapter 2400 is not limited to the above manner. For example, a magnet may be used, or a stationary type remote-control adapter may be used. In a case where remote-control adapter 2400 is attached to the instrument placed in a high place like air conditioner 110, preferably the magnet or the adhesion tape is used to surely attach remote-control adapter 2400.

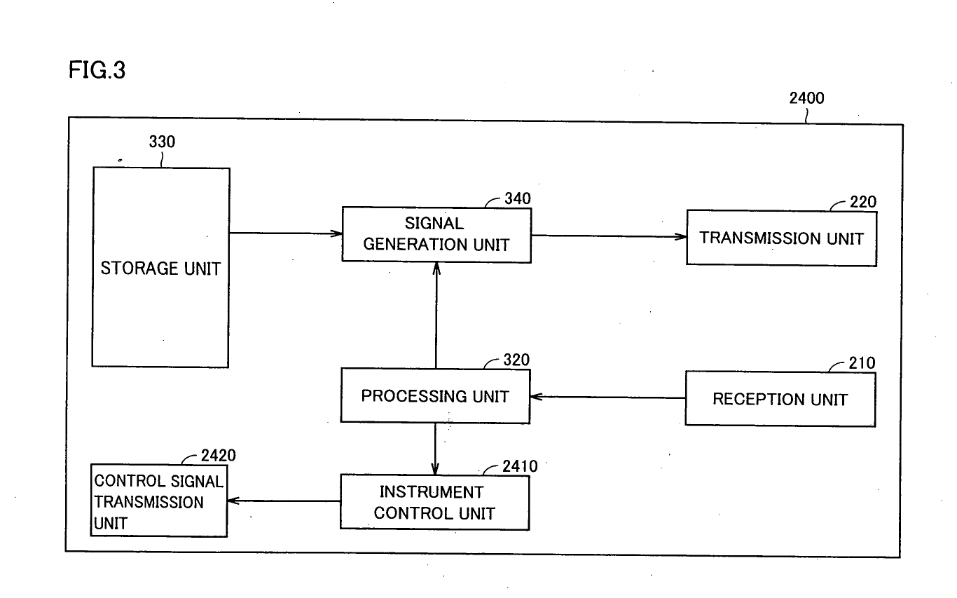

Referring to FIG. 3, a configuration of remote-control adapter 2400 will be described. FIG. 3 is a block diagram showing a functional configuration of remote-control adapter 2400. Remote-control adapter 2400 includes a reception unit 210, a transmission unit 220, a processing-unit 320, a storage unit 330, a signal generation unit 340, an instrument control unit 2410, and control signal transmission unit 2420.

Reception unit 210 receives the signal transmitted from remote controller 130 and transfers the signal to processing unit 320. Processing unit 320 obtains information included in the signal. The information includes a request of data for identifying remote-control adapter 2400. Processing unit 320 detects whether the signal received by reception unit 210 is the control signal for controlling the specific instrument or a control signal (in the embodiment, the control signal indicating the broadcast command is referred to as “broadcast signal”) indicating a broadcast command. Processing unit 320 transmits the signal to instrument control unit 2410 when processing unit 320 detects the reception of the control signal. The data for identifying remote-control adapter 2400 is previously stored in storage unit 330. Signal generation unit 340 generates an ID signal and transmits the ID signal to remote controller 130 based on the data stored in storage unit 330. Signal generation unit 340 transmits the ID signal to transmission unit 220. Transmission unit 220 transmits the ID signal in the form of the optical signal according to a predetermined blinking interval. The optical signal corresponds to blinking light 152 shown in FIG. 1. Transmission unit 220 includes LED (Light Emitting Diode). Instrument control unit 2410 generates the signal for controlling the instrument based on the signal obtained by processing unit 320. Control signal transmission unit 2420 converts the signal generated by instrument control unit 2410 into an infrared signal, and control signal transmits the infrared signal.

Instrument control unit 2410 converts the signal into a signal having a format in which the signal is transmitted as a remote-control code to the instrument, and instrument control unit 2410 transmits the signal to control signal transmission unit 2420. Therefore, the signal can be transmitted from control signal transmission unit 2420 while the format of the signal transmitted from remote controller 130 to control the instrument is compatible with the format of the instrument irrespective of a signal transmitting function of remote controller 130, which prevents a malfunction of the instrument due to nonconformity of the control signal format.

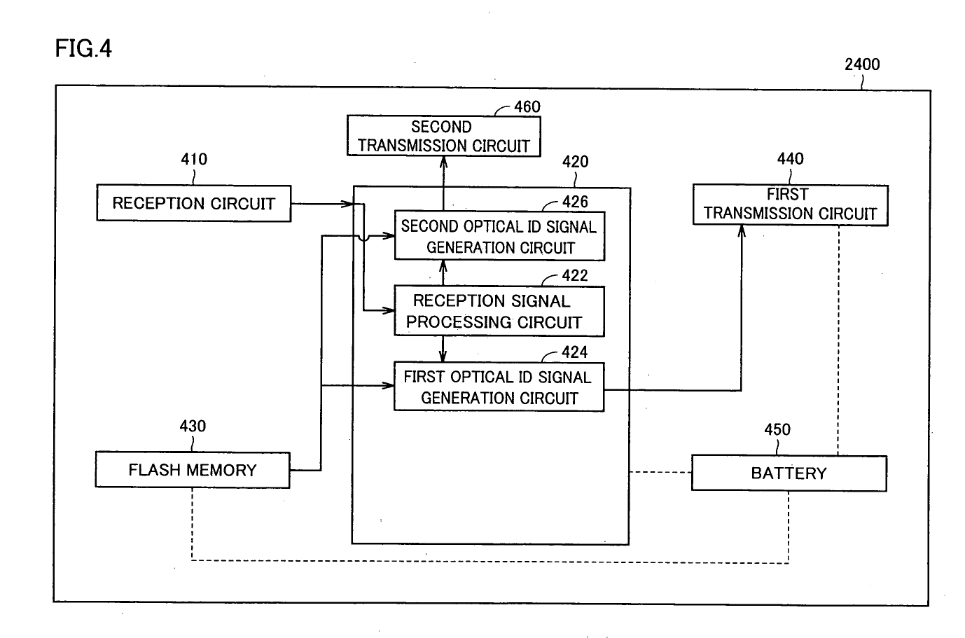

Referring to FIG. 4, the configuration of remote-control adapter 2400 will be further described. Remote-control adapter 2400 includes a reception circuit 410, a flash memory 430, a control circuit 420, a first transmission circuit 440, a battery 450, and a second transmission circuit 460. Reception circuit 410 receives a signal input from the outside. The data is stored in flash memory 430 in a non-volatile manner. Control circuit 420 generates the signal to remote controller 130 or the instrument to which remote-control adapter 2400 is attached based on the signal received by reception circuit 410 and the data stored in flash memory 430. First transmission circuit 440 transmits the signal generated by control circuit 420. Battery 450 supplies electric power to drive remote-control adapter 200. Second transmission circuit 460 converts the signal generated by control circuit 420 into the infrared signal, and second transmission circuit 460 transmits the infrared signal.

Control circuit 420 includes a reception-signal processing circuit 422, a first optical ID signal generation circuit 424, and a second optical ID signal generation circuit 426. Reception-signal processing circuit 422 obtains the information included in the signal by receiving the input of the signal transmitted from reception circuit 410. Based on the information (for example, identification information transmission command) obtained by reception-signal processing circuit 422 and the data stored in flash memory 430, first optical ID signal generation circuit 424 generates identification information transmitted in the form of the optical signal. Based on the information (for example, control signal for turning of the power) obtained by reception-signal processing circuit 422 and the data stored in flash memory 430, second optical ID signal generation circuit 426 generates control information transmitted in the form of the infrared signal.

In the embodiment, the same hardware as remote-control adapter 2400 is incorporated into HDD recorder 120.

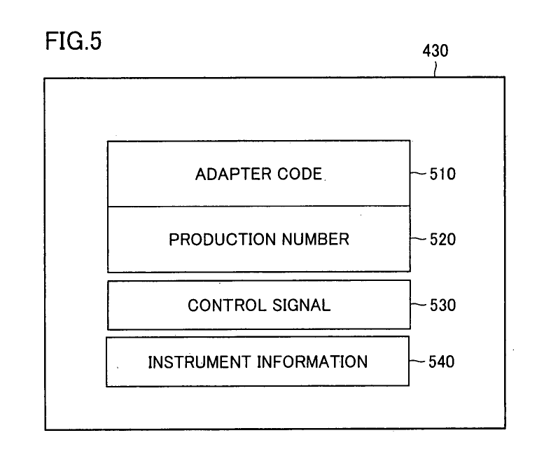

Referring to FIG. 5, a data structure of remote-control adapter 2400 will be described. Flash memory 430 includes Data storage areas 510, 520, 530, and 540. An adapter code for identifying remote-control adapter 200 is stored in area 510. The adapter code is one which is compatible with the instruments to which remote-control adapter 2400 is attached. A production number assigned by a manufacturer during production of remote-control adapter 2400 is stored in area 520. Information indicating contents of the control signal is stored in area 530 by the manufacturer when the manufacture produces remote-control adapter 2400. As used herein, “information indicating contents of the control signal” means information indicating a relationship between the signal transmitted from the remote controller 130 and the control signal transmitted to the instrument such as television 100. The information indicating contents of the control signal includes information indicating contents of control corresponding to the broadcast command. In the embodiment, the control corresponding to the broadcast command includes either of the following items. First contents are the same contents as control except for the control corresponding to the broadcast command. Second contents are a combination of pieces of control except for the control corresponding to the broadcast command. Therefore, at least a part of the contents of the control corresponding to the broadcast command overlaps any contents of other pieces of control. The information on the instrument to which remote-control adapter 2400 is attached is stored in area 540. The information on the instrument to which remote-control adapter 2400 is attached includes information on a manufacturer code of the instrument and information on an instrument number of the instrument. Remote-control adapter 2400 is specified by the pieces of information on the adapter code, the production number, and the instrument. These pieces of data are read by first optical ID signal generation circuit 424, and the optical signal is generated by first optical ID signal generation circuit 424.

The data stored in flash memory 430 to specify the remote-control adapter 200 is not limited to the data shown in FIG. 5. The data may be rewritable. In this case, the information indicating the contents of the control corresponding to the broadcast command may be information which can arbitrarily set by a user through a method such as teaching.

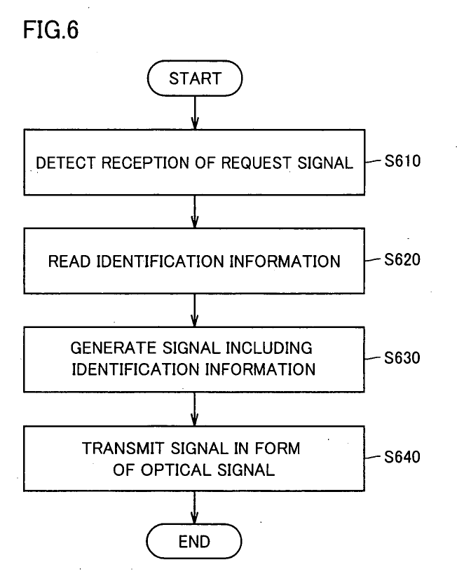

Referring to FIG. 6, a control structure of remote-control adapter 2400 of the embodiment will be described. FIG. 6 is a flowchart showing a procedure of a process performed by control circuit 420. The process is performed when remote-control adapter 2400 is in a so-called sleep mode and, at the same time, when the infrared ray having a particular wavelength is inputted from the outside.

In Step S610, control circuit 420 detects the reception of the request signal for requesting the ID signal based on the signal received by reception circuit 410. The request signal is transmitted from remote controller 130, when a user inputs an instruction to remote controller 130 to request the ID signal. At this point, remote controller 130 generates the signal including the request signal and outputs the signal through light-emitting unit 140.

In Step S620, control circuit 420 reads the identification information stored in flash memory 430. In the embodiment, the identification information is data including the pieces of information on the adapter code, the production number, and the instrument.

In Step S630, control circuit 420 generates the ID signal including the read identification information. In Step S640, control circuit 420 transmits the ID signal in the form of the blinking optical signal to first transmission circuit 440. Therefore, remote-control adapter 2400 outputs the signal including the identification information in the form of the optical signal toward a predetermined direction.

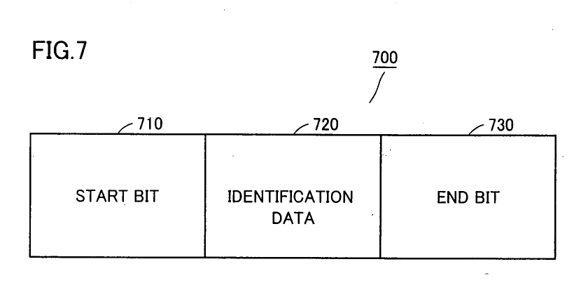

Referring to FIG. 7, a configuration of an optical ID signal 700 transmitted by remote-control adapter 2400 will be described. FIG. 7 conceptually shows the configuration of optical ID signal 700. Optical ID signal 700 includes data storage areas 710, 720, and 730.

A start bit indicating a leading end of optical ID signal 700 is stored in start-bit area 710. The identification information on remote-control adapter 200 is stored in identification information area 720. An end bit indicating the end of optical ID signal 700 is stored in end-bit area 730. Optical ID signal 700 of FIG. 7 is periodically transmitted from remote-control adapter 2400. Optical ID signal 700 is transmitted for a predetermined time interval, e.g., a predetermined interval after the sleep mode is released. In this case, the leading end of each optical ID signal 700 is specified by the start bit, so that remote controller 130 receiving the optical ID signal can easily specify the leading end of optical ID signal 700.

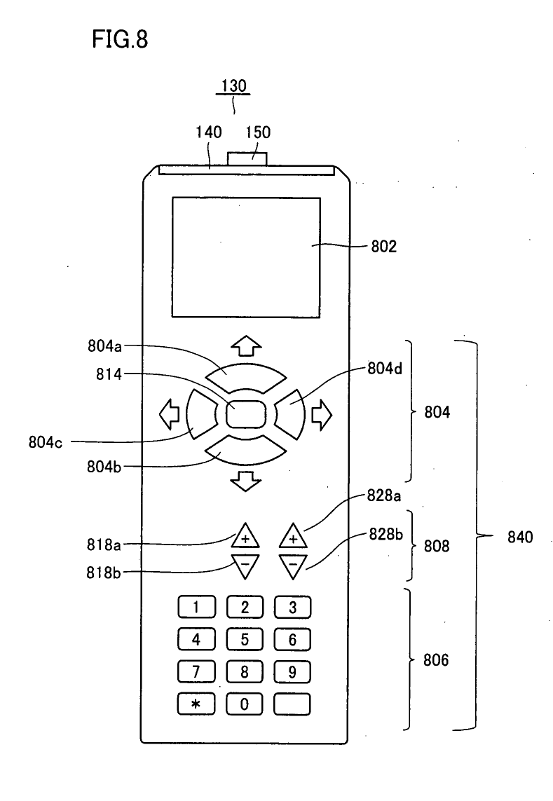

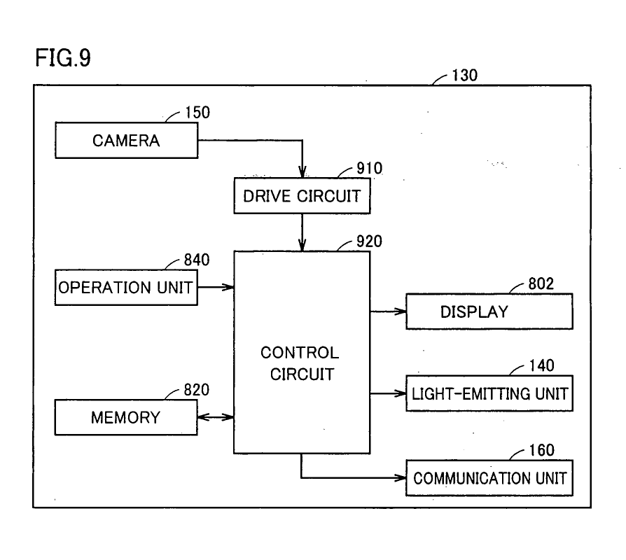

Referring to FIGS. 8 and 9, remote controller 130 of the embodiment will be described. FIG. 8 shows an appearance of remote controller 130.

Remote controller 130 includes camera 150, light-emitting unit 140, a display 802, and an operation unit 840. Camera 150 images a subject to generate a video signal. Light-emitting unit 140 emits light of the control signal to a controlled instrument. Operation unit 840 receives an instruction from the outside and outputs a signal according to the instruction.

For example, camera 150 is realized by a light-acceptance element having a photoelectric conversion function and an element having a signal transfer function such as CCD (Charge Coupled Device). For example, display 802 is realized by a liquid crystal display or an organic EL (Electro Luminescent) display.

Operation unit 840 is realized by a button or a dial. Operation unit 840 includes cursor buttons 804a, 804b, 804c, and 804d, a decision button 814, an up-and-down button 808, and a numerical button 806. Cursor buttons 804a, 804b, 804c, and 804d regulate vertical and horizontal directions of a cursor displayed on display 802. Decision button 814 accepts an input of a user instruction for deciding a data inputted through remote controller 130. Up-and-down button 808 increments or decrements an output value of the control signal. Up-and-down button 808 includes a first up button 818a, a first down button 818b, a second up button 828a, and a second down button 828b.

Referring to FIG. 9, remote controller 130 includes camera 150, a drive circuit 910, operation unit 840, a control circuit 920, a memory 820, display 802, light-emitting unit 140, and communication unit 160. Drive circuit 910 receives the signal from camera 150. Operation unit 840 accepts the input of the instruction from the outside. Control circuit 920 generates the signal, with which remote controller 130 performs the predetermined process, based on the data or command inputted from the outside. The data can be written in and read from memory 820. Display 802 displays the image based on the signal generated by control circuit 920. Light-emitting unit 140 outputs the signal generated by control circuit 920. Communication unit 160 conducts communication with a telephone (not shown).

The signal generated by drive circuit 910 is inputted to control circuit 920. Control circuit 920 performs predetermined image processing to the signal, and control circuit 920 generates the data for displaying the image on display 802. Operation unit 840 outputs an electric signal to control circuit 920 according to the inputted instruction. Control circuit 920 performs a predetermined process according to the signal. In the embodiment, it is assumed that the signal generated by control unit 920 according to the operation of operation unit 840 is previously defined. The signal is not changed according to the instrument controlled by remote controller 130. Camera 150 receives the optical signal including the control signal which is previously defined between the controlled instrument and the remote controller 130. Camera 150 has a photoelectric conversion function of converting the signal into the electric signal, and camera 150 transmits the converted signal to drive circuit 910.

The data is stored in memory 820 in a non-volatile manner. For example, memory 820 is realized by a flash memory. In memory 820, when the data for specifying the function of the controlled instrument is received from control circuit 920, the data is stored in a predetermined area.

Control circuit 920 generates the signal according to the user operation to the operation unit 840, and control circuit 920 transmits the signal to light-emitting unit 140. Sometimes, control circuit 920 is realized by a circuit element previously configured to perform each process, or sometimes control circuit 920 is realized by executing a program for performing each process with CPU (Central Processing Unit) or a processor.

Light-emitting unit 140 transmits the control signal obtained from control circuit 920 to the outside. In a certain aspect, light-emitting unit 140 transmits the infrared signal. In another aspect, light-emitting unit 140 is connected to a communication line to perform a process transmitting the control signal in the form of a packet. The output mode of the control signal is not limited to the infrared signal. For example, the output mode may be transmission pursuant to other wireless communication techniques such as Bluetooth®.

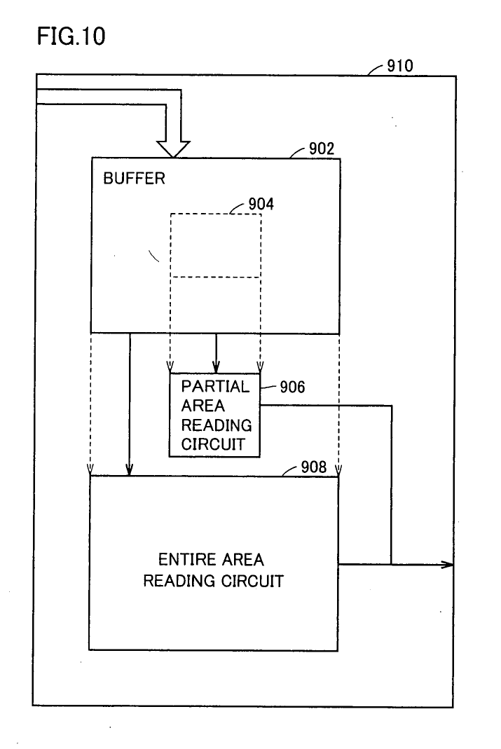

Referring to FIG. 10, drive circuit 910 of the embodiment will be further described. Drive circuit 910 analyses the inputted signal to obtain the information included in the signal, e.g., the identification information for specifying a transmission source of the signal.

Drive circuit 910 includes a buffer 902, an entire area reading circuit 908, and a partial area reading circuit 906. Buffer 902 receives the video signal from camera 150, and the video signal is stored in buffer 902. Entire area reading circuit 908 reads the data corresponding to the entire area defined to buffer 902 according to the display area in display 802. Partial area reading circuit 906 reads the data stored in a partial area 904 which is defined in buffer 902 as the partial area according to a part of the display area in display 802.

Entire area reading circuit 908 reads the signal stored in buffer 902 according to a predetermined processing rate. The read signal is transmitted to control circuit 920. When display 802 displays the image based on the signal, the entire image of the subject taken by camera 150 is displayed on the entire display area in display 802.

Partial area reading circuit 906 reads the signal stored in partial area 904 of buffer 902. In this case, a reading rate is faster than a reading rate in a case where the signal from the entire area of buffer 902. That is, the area which becomes a target of the reading process performed by partial area reading circuit 906 is smaller than that of the reading process performed by entire area reading circuit 908, so that the signal stored in partial area 904 is read at a rate higher than that of the signal corresponding to the entire area. Partial area reading circuit 906 sequentially reads the data at a rate higher than that of entire area reading circuit 908, and partial area reading circuit 906 transmits the signal to control circuit 920.

This enables control circuit 920 to perform the signal reading process at a higher rate compared with the usual image processing performed based on the video image taken by camera 150. As a result, even if the subject is in a state of stand still, the signal, e.g., the infrared ray generated by the subject is taken in the predetermined partial area by camera 150, which allows the information to be obtained based on the signal.

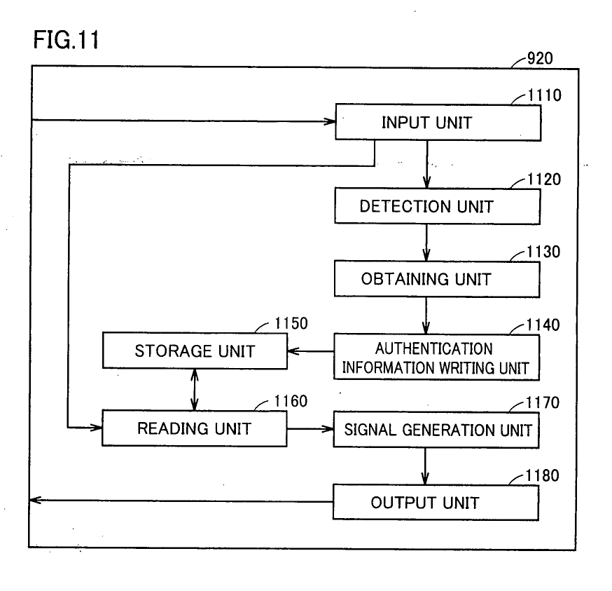

Referring to FIG. 11, a functional configuration of control circuit 920 of remote controller 130 will be described.

Control circuit 920 includes an input unit 1110, a detection unit 1120, an obtaining unit 1130, an authentication information writing unit 1140, a storage unit 1150, a reading unit 1160, a signal generation unit 1170, and an output unit 1180. Input unit 1110 receives the signal from the outside. Detection unit 1120 detects the information included in the signal based on the signal received by the input unit 111.0. Obtaining unit 1130 obtains the particular information from the detected signal. Authentication information writing unit 1140 performs a process of storing the authenticated information based on the obtained information. The data is stored in storage unit 1150. Reading unit 1160 reads the data stored in storage unit 1150 based on the input through the input unit 1110. Based on the data read by reading unit 1160, signal generation unit 1170 generates the signal for controlling the controlled instrument. Output unit 1180 outputs the signal generated by signal generation unit 1170.

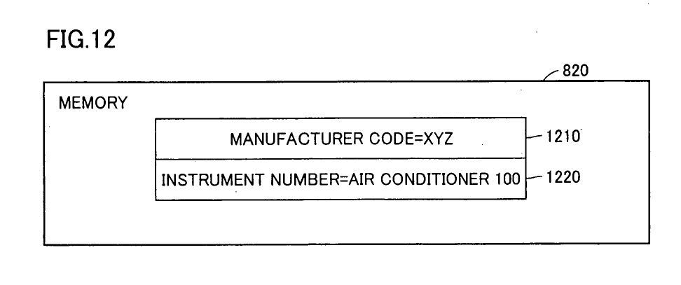

Referring to FIG. 12, a data structure of remote controller 130 will be described. FIG. 12 shows the data stored in memory 820 when remote controller 130 authenticates air conditioner 110 as a control target.

A manufacturer code (XYZ) of air conditioner 110 is stored in a manufacturer code area 1210. An instrument number (AIR CONDITIONER 100) of air conditioner 110 is stored in an instrument number area 1220.

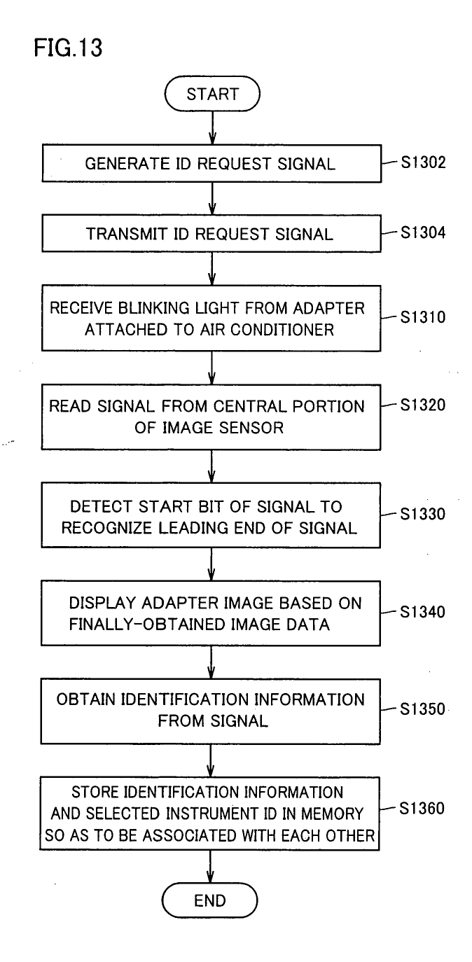

Referring to FIG. 13, a control structure of remote controller 130 of the embodiment will be described. FIG. 13 is a flowchart showing a procedure of a process performed by control circuit 920 to authenticate air conditioner 110.

In Step S1302, control circuit 920 generates an ID request signal for requesting the transmission of the identification information on the remote-control adapter 2400 based on the instruction inputted through operation unit 840 by a user. In the embodiment, when decision button 814 is pressed for a predetermined time interval or more, control circuit 920 generates the ID request signal.

In Step S1304, control circuit 920 transmits the ID request signal through light-emitting unit 140. The ID request signal is transmitted within a predetermined irradiation range. When remote-control adapter 2400 exists within the range, remote-control adapter 2400 receives the ID request signal (Step S610), and remote-control adapter 2400 transmits the optical signal including the identification information.

In Step S1310, control circuit 920 receives the blinking light emitted from remote-control adapter 2400b attached to air conditioner 110. In Step S1320, control circuit 920 reads the signal obtained in a central portion of camera 150 which functions as an image sensor. In Step S1330, control circuit 920 recognizes the leading end of the signal by detecting the start bit of the signal. In Step S1340, control circuit 920 causes display 802 to display the image of air conditioner 110 including remote-control adapter 2400b based on the latest image data obtained by camera 150.

In Step S1350, control circuit 920 obtains the identification information on remote-control adapter 2400b from the obtained information.

In Step S13.60, control circuit 920 stores the manufacturer code information and the instrument number information in area 1210 and area 1220 of memory 820 respectively. As described above, the manufacturer code information and the instrument number information are included in the identification information.

Therefore, when the instruction is inputted to remote controller 130 through operation unit 840, remote controller 130 can generate and transmit the signal for controlling air conditioner 110.

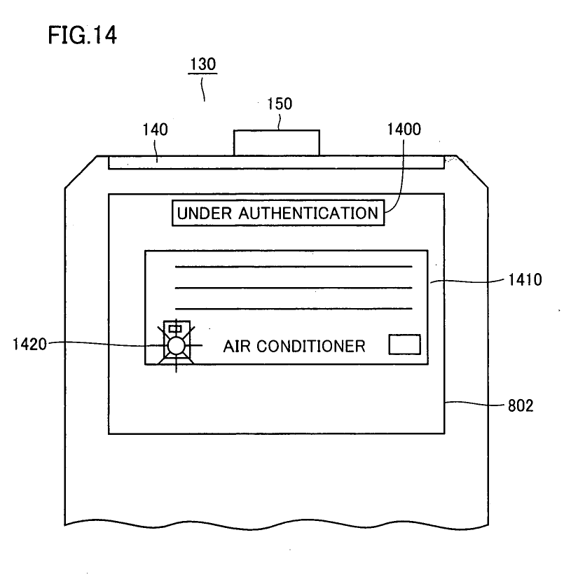

Referring to FIG. 14, a display mode in display 802 of remote controller 130 will be described. FIG. 14 shows the image displayed on display 802 when remote controller 130 performs a process of authenticating air conditioner 110.

Remote controller 130 displays an image 1410 of air conditioner 110 and an image 1420 of remote-control adapter 2400b on display 802. At this point, remote controller 130 displays a message 1400 indicating that the authentication process is being performed. Accordingly, the user of remote controller 130 can easily recognize a current status of remote controller 130.

A case where remote controller 130 functions as a remote controller of another controlled instrument will be described. In this case, it is assumed that remote controller 130 which initially functions as a remote controller of air conditioner 110 functions as a remote controller of HDD recorder 120 after performing the process of authenticating the controlled instrument again.

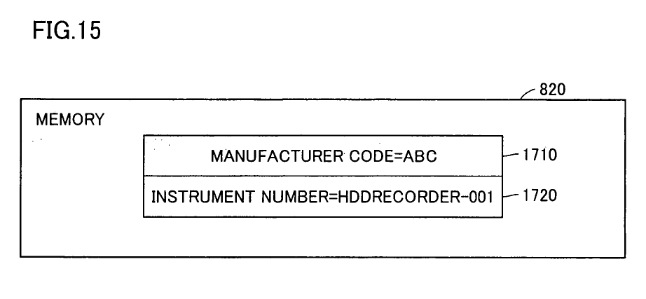

Referring to FIG. 15, a data structure of remote controller 130 will be described. FIG. 15 conceptually shows the data stored in memory 820 of remote controller 130 after remote controller 130 authenticates HDD recorder 120. When remote controller 130 authenticates HDD recorder 120, the data of FIG. 15 is used in place of the data of FIG. 12. As a result, remote controller 130 which functions in order to remotely operate air conditioner 110 functions as the remote controller of HDD recorder 120.

Specifically, a manufacturer code “ABC” of HDD recorder 120 is stored in a manufacturer code area 1710. An instrument number “HDD RECORDER-001” of HDD recorder 120 is stored in an instrument number area 1720.

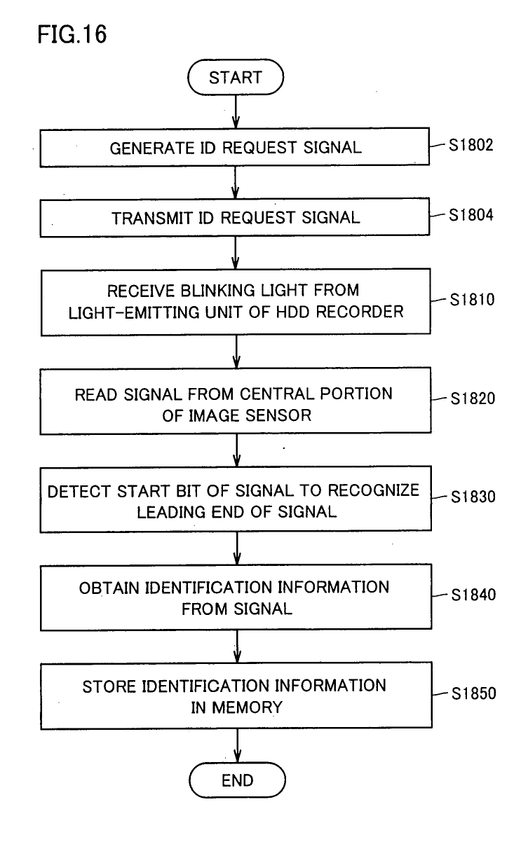

Referring to FIG. 16, the control structure of remote controller 130 will be further described. FIG. 16 is a flowchart showing a procedure of a process performed by remote controller 130 which is already authenticates a controlled instrument to authenticate another controlled instrument. For example, the process of FIG. 16 is performed when a user of remote controller 130 which already authenticates air conditioner 110 performs an imaging process with HDD recorder 120.

A case where HDD recorder 120 includes light-emitting unit 122 will be described here. Light-emitting unit 122 transmits the optical ID signal including the manufacturer code, the instrument number, the adapter code, and other pieces of identification information in the form of the blinking light. HDD recorder 120 may include remote-control adapter 2400 of the invention in place of light-emitting unit 122.

In Step S1802, control circuit 920 generates the ID request signal for requesting the transmission of the identification information on HDD recorder 120 based on the user instruction inputted through operation unit 840. In Step S1804, control circuit 920 transmits the ID request signal through light-emitting unit 140. The ID request signal is transmitted within a predetermined irradiation range. When light-acceptance unit 124 of HDD recorder 120 exists within the range, light-acceptance unit 124 receives the ID request signal (Step S1810), and light-emitting unit 122 of HDD recorder 120 transmits the optical signal including the identification information.

In Step S1810, control circuit 920 receives the blinking light emitted by light-emitting unit 122 of HDD recorder 120 through camera 150. In Step S1820, control circuit 920 reads the signal obtained in the central portion of the image sensor (camera 150) through drive circuit 910.

In Step S1830, control circuit 920 recognizes the leading end of the signal by detecting the start bit of the signal. In Step S1840, control circuit 920 obtains the identification information included in the signal. In Step S1850, control circuit 920 writes the identification information (such as the manufacturer code and instrument number of the HDD recorder 120) in the predetermined area of memory 820.

Therefore, when the instruction is inputted to remote controller 130 through operation unit 840, remote controller 130 can generate and transmit the signal for controlling HDD recorder 120.

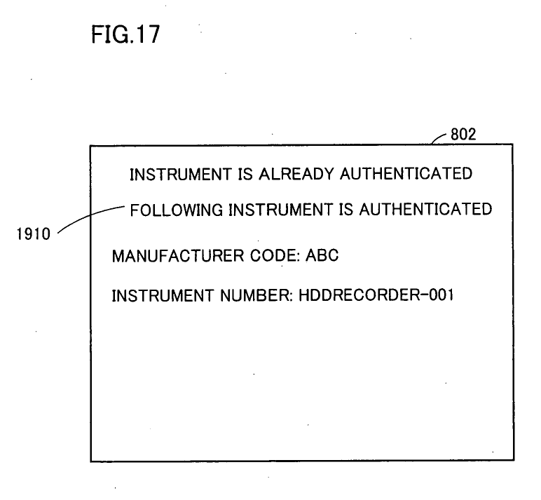

Referring to FIG. 17, the display mode of the image on display 802 of remote controller 130 will be described again. FIG. 17 shows an image displayed when remote controller 130 authenticates HDD recorder 120.

When the user operates remote controller 130 toward light-emitting unit 122 of HDD recorder 120 to receive the signal, remote controller 130 performs the authentication process to recognize HDD recorder 120. When remote controller 130 obtains the identification information included in the signal received from HDD recorder 120, remote controller 130 writes the identification information in memory 820. In this case, when another controlled instrument is already authenticated, the data is written in another data area of memory 820. Alternatively, the data concerning the newly-recognized instrument is overwritten in the already-written area.

When the authentication process is completed, remote controller 130 displays a message 1910 for notifying the user that the new instrument is authenticated on the display 802. At this point, display 802 displays the information of HDD recorder 120 which is of the authenticated controlled instrument. Therefore, the specific information on the instrument is displayed according to the authentication state of the remote controller 130, so that the user of remote controller 130 can operate the terminal without fail.

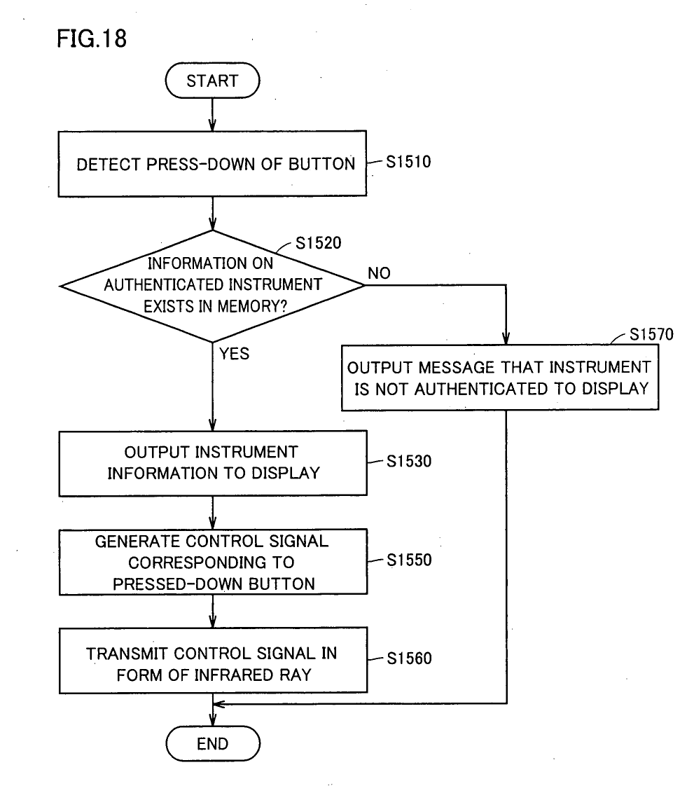

Referring to FIG. 18, the control structure of remote controller 130 will be described again. FIG. 18 is a flowchart showing a procedure of a process performed by remote controller 130 to control the controlled instrument. The process of FIG. 18 is performed when the user uses remote controller 130 as the remote controller dedicated to a particular controlled instrument (for example, HDD recorder 120, television 100, and air conditioner 110).

In Step S1510, control circuit 920 detects press-down of the button based on the input through operation unit 840. In Step S1520, control circuit 920 determines whether or not the information on the authenticated instrument exists in manufacturer code area 1210 and instrument number area 1220 of memory 820. When the information on the authenticated instrument exists (YES in Step S1520), the flow goes to Step S1530. When the information on the authenticated instrument does not exist (NO in Step S1520), the flow goes to Step S1570.

In Step S1530, control circuit 920 outputs the information on the authenticated instrument to display 802. Display 802 displays the information on the authenticated instrument.

In Step S1550, control circuit 920 generates the control signal corresponding to the pressed-down button. In Step S1560, control circuit 920 outputs the infrared ray indicating the control signal through light-emitting unit 140.

In Step S1570, control circuit 920 outputs a message notifying the user that the instrument is not authenticated on display 802. Display 802 displays the message on its display area.

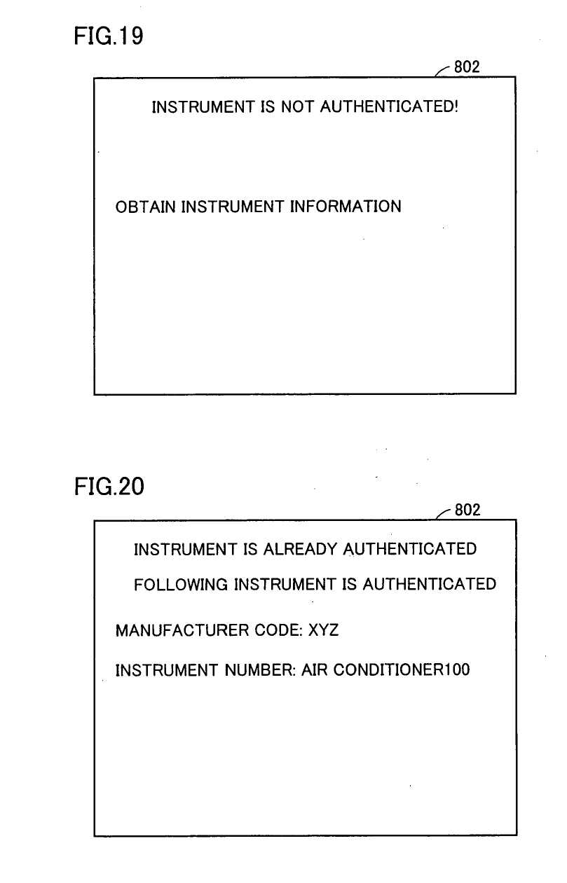

Referring to FIGS. 19 and 20, the display mode of the image on display 802 will be described. FIGS. 19 and 20 show images displayed as a result of authentication performed by remote controller 130.

FIG. 19 shows the image displayed when remote controller 130 does not authenticate the controlled instrument. Display 802 displays that the authentication of the controlled instrument is not completed, and display 802 also displays the message for encouraging the user to obtain the information on the instrument. The data is previously stored in memory 820, and the data is read when the process in Step S1570 is performed, which realizes the display of FIG. 19. The display of FIG. 19 enables the user of remote controller 130 to immediately recognize that the authentication process is not completed. In this case, the user operates remote controller 130 toward transmission unit 220 of remote-control adapter 2400 to obtain optical ID signal 700, thus enabling the user to surely realize the process of authenticating the controlled instrument.

FIG. 20 shows an image displayed when remote controller 130 authenticates the controlled instrument. The data is previously stored in memory 820, and the data is read when the process in Step S1530 is performed, which realizes the display of FIG. 20. FIG. 20 shows that the instrument having the manufacturer code “XYZ” and the instrument number “AIR CONDITIONER 100” is authenticated as the already-authenticated instrument.

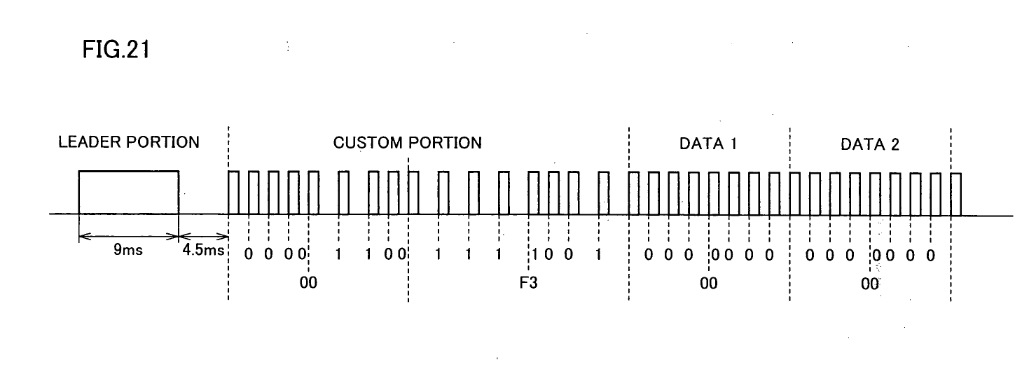

FIG. 21 shows a format of a remote-control code transmitted by remote controller 130. In the embodiment, the remote-control code signal transmitted by remote controller 130 includes a leader portion, a custom portion, and a data portion. The leader portion indicates that the remote-control code signal is transmitted from now. The custom portion indicates a manufacturer name of the instrument which is of the control target. The data portion indicates contents of the control. In the embodiment, the leading end parts of the custom portion and data portion indicate the instrument which is of the control target. The remaining of the data portion indicates the contents of the control. Control circuit 920 generates the control signal based on the information stored in manufacturer code area 1210, the information stored in instrument number area 1220, and the pressed-down button. When the remote-control code indicating the broadcast command is transmitted, control circuit 920 generates the control signal irrespective of the information stored in manufacturer code area 1210 and the information stored in instrument number area 1220. In the control signal, the signal included in the custom portion indicates a predetermined value. The “predetermined value” is not particularly limited. When the signal included in the custom portion indicates the predetermined value, the leading end part of the data portion indicates a type of the broadcast command.

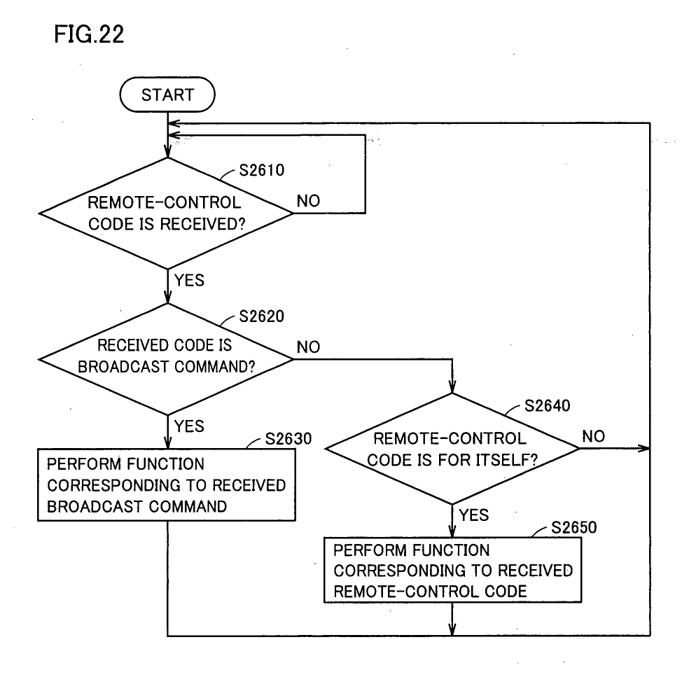

Referring to FIG. 22, a program realized by remote-control adapter 2400 of the embodiment performs the following control with respect to the execution of the broadcast command.

In Step S2610, control circuit 420 of remote-control adapter 2400 determines whether or not reception circuit 410 receives the remote-control code. When control circuit 420 determines that reception circuit 410 receives the remote-control code (YES in Step S2610), the flow goes to Step S2620. When control circuit 420 determines that reception circuit 410 does not receive the remote-control code (NO in Step S2610), the flow goes to Step S2610.

In Step S2620, control circuit 420 determines whether or not the remote-control code received by reception circuit 410 indicates the broadcast command based on the leading end parts of the custom portion and data portion of the remote-control code. When control circuit 420 determines that the remote-control code indicates the broadcast command (YES in Step S2620), the flow goes to Step S2630. When control circuit 420 determines that the remote-control code does not indicate the broadcast command (NO in Step S2620), the flow goes to Step S2640.

In Step S2630, control circuit 420 performs the function corresponding to the broadcast command received by reception circuit 410. That is, control circuit 920 performs the following processes. A first process is a process of reading the data, stored in memory 820, which indicates the broadcast command. A second process is a process of generating the control signal corresponding to the data read in the first process. A third process is a process of outputting the infrared ray indicating the control signal generated in the second process through second transmission circuit 460. In a case where HDD recorder 120 receives the broadcast command, HDD recorder 120 may perform the following processes. A first process is a process of reading the data, stored in memory 820, which indicates the broadcast command. A second process is a process of operating HDD recorder 120 based on the data read in the first process.

In Step S2640, control circuit 420 determines whether or not the remote-control code received in Step S2610 is the remote-control code for control circuit 420 based on the leading end parts of the custom portion and data portion of the remote-control code. When control circuit 420 determines that the remote-control code is the remote-control code for control circuit 420 (YES in Step S2640), the flow goes to Step S2650. When control circuit 420 determines that the remote-control code is not the remote-control code for control circuit 420 (NO in Step S2640), the flow goes to Step S2610.

In Step S2650, control circuit 420 performs the function corresponding to the received remote-control code. That is, control circuit 920 performs the following processes. A first process is a process of reading the data, stored in memory 820, corresponding to the received remote-control code. A second process is a process of generating the control signal corresponding to the data read in the first process. A third process is a process of outputting the infrared ray indicating the control signal generated in the second process through second transmission circuit 460.

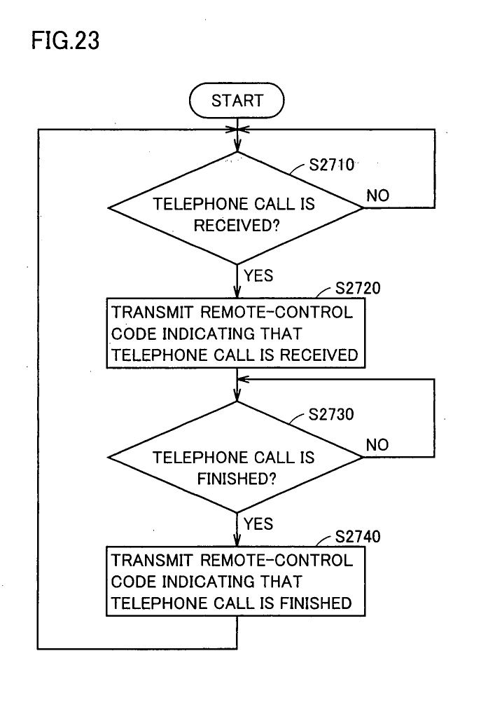

Referring to FIG. 23, a program executed by remote controller 130 performs the following control with respect to the action at the time a telephone call is received.

In Step S2710, control circuit 920 of remote controller 130 determines whether or not the telephone call is received based on whether or not communication unit 160 receives a ringing signal from the telephone (not shown). When control circuit 920 determines that the telephone call is received (YES in Step S2710), the flow goes to Step S2720. When control circuit 920 determines that the telephone call is not received (NO in Step S2710), the flow goes to Step S2710.

In Step S2720, light-emitting unit 140 of remote controller 130 transmits the remote-control code notifying remote-control adapter 2400 and HDD recorder 120 that the telephone call is received. Remote-control adapter 2400 and HDD recorder 120 regard the remote-control code as the broadcast command based on contents of the custom portion of the remote-control code.

In Step S2730, control circuit 920 of remote controller 130 determines whether or not the telephone is finished based on whether or not communication unit 160 receives the signal indicating that a telephone receiver is hung up from the telephone (not shown). When control circuit 920 determines that the telephone is finished (YES in Step S2730), the flow goes to Step S2740. When control circuit 920 determines that the telephone is not finished (NO in Step S2730), the flow goes to Step S2730.

In Step S2740, light-emitting unit 140 of remote controller 130 transmits the remote-control code notifying remote-control adapter 2400 and HDD recorder 120 that the telephone is finished. Remote-control adapter 2400 and HDD recorder 120 regard the remote-control code as the broadcast command based on the contents of the custom portion of the remote-control code.

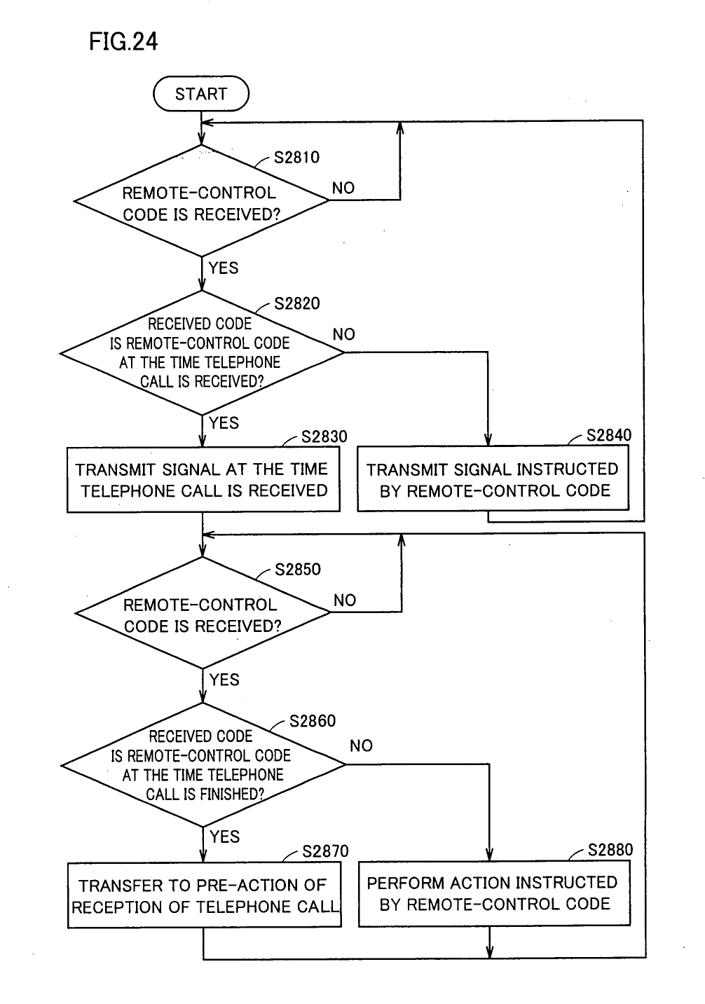

Referring to FIG. 24, a program executed by remote-control adapter 2400 performs the following control with respect to the action at the time a telephone call is received.

In Step S2810, control circuit 420 of remote-control adapter 2400 determines whether or not reception circuit 410 receives the remote-control code. When control circuit 420 determines that reception circuit 410 receives the remote-control code (YES in Step S2810), the flow goes to Step S2820. When control circuit 420 determines that reception circuit 410 does not receive the remote-control code (NO in Step S2810), the flow returns to Step S2810.

In Step S2820, control circuit 420 determines whether or not reception circuit 410 receives the remote-control code at the time the telephone call is received based on the contents of the leading end parts of the custom portion and data portion. When control circuit 420 determines that reception circuit 410 receives the remote-control code at the time the telephone call is received (YES in Step S2820), the flow goes to Step S2830. When control circuit 420 determines that reception circuit 410 does not receive the remote-control code at the time the telephone call is received (NO in Step S2820), the flow goes to Step S2840.

In Step S2830, control circuit 420 transmits the control signal at the time the telephone call is received. Therefore control circuit 920 performs the following processes. A first process is a process of reading the data, stored in memory 820, which indicates the contents of the control at the time the telephone call is received. A second process is a process of generating the control signal corresponding to the data read in the first process. A third process is a process of outputting the infrared ray indicating the control signal generated in the second process through second transmission circuit 460. In a case where HDD recorder 120 receives the remote-control code at the time the telephone call is received, HDD recorder 120 may be perform the following processes. A first process is a process of reading the data, stored in memory 820, which indicates the action at the time the telephone call is received. A second process is a process of operating HDD recorder 120 based on the data read in the first process.

In Step S2840, control circuit 420 transmits the contents of the signal which is specified by the remote-control code received by reception circuit 410. Therefore, control circuit 920 performs the following processes. A first process is a process of reading the data, stored in memory 820, which indicates the contents specified by the remote-control code. A second process is a process of generating the control signal corresponding to the data read in the first process. A third process is a process of outputting the infrared ray indicating the control signal generated in the second process through second transmission circuit 460.

In Step S2850, control circuit 420 determines whether or not reception circuit 410 receives the remote-control code. When control circuit 420 determines that reception circuit 410 receives the remote-control code (YES in Step S2850), the flow goes to Step S2860. When control circuit 420 determines that reception circuit 410 does not receive the remote-control code (NO in Step S2850), the flow returns to Step S2850.

In Step S2860, control circuit 420 determines whether or not reception circuit 410 receives the remote-control code at the time the telephone call is finished based on the contents of the leading end parts of the custom portion and data portion. When control circuit 420 determines that reception circuit 410 receives the remote-control code at the time the telephone call is finished (YES in Step S2860), the flow goes to Step S2870. When control circuit 420 determines that reception circuit 410 does not receive the remote-control code at the time the telephone call is finished (NO in Step S2860), the flow goes to Step S2880.

In Step S2870, control circuit 420 of remote-control adapter 2400 outputs the signal for transferring to the previous action of the reception of the telephone call through second transmission circuit 460. Control circuit 420 of HDD recorder 120 transfers to the previous action of the reception of the telephone call.

In Step S2880, control circuit 420 of remote-control adapter 2400 transmits the signal to perform the action instructed by the remote-control code. Therefore, control circuit 920 performs the following processes. A first process is a process of reading the data, stored in memory 820, which indicates the contents specified by the remote-control code. A second process is a process of generating the control signal corresponding to the data read in the first process. A third process is a process of outputting the infrared ray indicating the control signal generated in the second process through second transmission circuit 460.

The action of the control system of the embodiment will be described below based on the above structures and flowcharts.

(A Case where Remote Controller 130 Transmits Broadcast Command for Sleep)

Control circuit 920 detects the press-down of the button based on the user input through operation unit 840 (Step S1510). When control circuit 920 detects the press-down of the button, control circuit 920 determines whether or not the information on the authenticated instrument exists in manufacturer code area 1210 and instrument number area 1220 of memory 820 (Step S1520). When control circuit 920 determines that the information on the authenticated instrument exists (YES in Step S1520), control circuit 920 outputs the information on the authenticated instrument to display 802 (Step S1530). When control circuit 920 outputs the information to display 802, control circuit 920 generates the control signal corresponding to the pressed-down button (Step S1550). In this case, when the user operates the key for the broadcast command for sleep, control circuit 920 generates the control signal for the broadcast command for sleep. When the control signal is generated, control circuit 920 outputs the infrared ray indicating the control signal through light-emitting unit 140 (Step S1560).

When control circuit 920 outputs the infrared ray, control circuit 420 of remote-control adapter 2400a attached to television 100 determines whether or not reception circuit 410 receives the remote-control code (Step S2610). When circuit 420 determines that reception circuit 410 receives the remote-control code (YES in Step S2610), control circuit 420 determines whether or not the remote-control code received by reception circuit 410 indicates the broadcast command for sleep (Step S2620). When control circuit 420 determines that the remote-control code indicates the broadcast command for sleep (YES in Step S2620), second transmission circuit 460 outputs the infrared ray indicating control for sleep (Step S2630). In the embodiment, it is assumed that the control for sleep to television 100 is one in which the power is turned off after a predetermined time elapses. When second transmission circuit 460 outputs the infrared ray, light-acceptance unit 102 of television 100 receives the infrared ray as the control signal. When the control signal is received, the power is turned off after a predetermined time elapses in television 100.

When second transmission circuit 460 outputs the infrared ray, control circuit 420 of remote-control adapter 2400b attached to air conditioner 110 determines whether or not reception circuit 410 receives the remote-control code (Step S2610). When control circuit 420 determines that reception circuit 410 receives the remote-control code (YES in Step S2610), control circuit 420 determines whether or not the remote-control code received by reception circuit 410 indicates the broadcast command for sleep (Step S2620). In this case, because control circuit 420 determines that the remote-control code indicates the broadcast command for sleep (YES in Step S2620), second transmission circuit 460 outputs the infrared ray indicating the control for sleep (Step S2630). In the embodiment, for the control for sleep to air conditioner 110, it is assumed that a room temperature is kept at a certain level and the power is turned off after a predetermined time elapses. When second transmission circuit 460 outputs the infrared ray, a light-acceptance unit (not shown) of air conditioner 110 receives the infrared ray as the control signal. When the control signal is received, the room temperature is kept at a certain level and the power is turned off after a predetermined time elapses in air conditioner 110.

When second transmission circuit 460 outputs the infrared ray, control circuit 420 incorporated into HDD recorder 120 determines whether or not reception circuit 410 receives the remote-control code (Step S2610). When control circuit 420 determines that reception circuit 410 receives the remote-control code (YES in Step S2610), control circuit 420 determines whether or not the remote-control code received by reception circuit 410 indicates the broadcast command for sleep (Step S2620). In this case, because control circuit 420 determines that the remote-control code indicates the broadcast command for sleep (YES in Step S2620), HDD recorder 120 is operated based on the broadcast command for sleep (Step S2630). In the embodiment, for the control for sleep to HDD recorder 120, it is assumed that the contents are reproduced once before the power is turned off. Therefore, HDD recorder 120 reproduces the contents once before the power is turned off.

(A Case where Telephone Call is Received)

Control circuit 920 of remote controller 130 determines whether or not the telephone call is received (Step S2710). When control circuit 920 determines that the telephone call is received (YES in Step S152710), light-emitting unit 140 of remote controller 130 transmits the remote-control code indicating that the telephone call is received (Step S2720).

Control circuit 420 of remote-control adapter 2400a attached to television 100 determines whether or not reception circuit 410 receives the remote-control code (Step S2810). When control circuit 420 determines that reception circuit 410 receives the remote-control code (YES in Step S2810), control circuit 420 of remote-control adapter 2400a determines whether or not reception circuit 410 receives the remote-control code at the time the telephone call is received (Step S2820). When control circuit 420 determines that reception circuit 410 receives the remote-control code at the time the telephone call is received (YES in Step S2820), control circuit 420 transmits the control signal at the time the telephone call is received (Step S2830). In the embodiment, for the control at the time the telephone call is received, it is assumed that the volume is set to a predetermined level. When the control signal is transmitted, light-acceptance unit 102 of television 100 receives the control signal. When the control signal is received, the volume is set to a predetermined level in television 100.

Control circuit 420 of remote-control adapter 2400b attached to air conditioner 110 determines whether or not reception circuit 410 receives the remote-control code (Step S2810). When control circuit 420 determines that reception circuit 410 receives the remote-control code (YES in Step S2810), control circuit 420 determines whether or not reception circuit 410 receives the remote-control code at the time the telephone call is received (Step S2820). When control circuit 420 determines that reception circuit 410 receives the remote-control code at the time the telephone call is received (YES in Step S2820), control circuit 420 transmits the control signal at the time the telephone call is received (Step S2830). In the embodiment, for the control to air conditioner 110 at the time the telephone call is received, it is assumed that the action at the time the control signal is received is continued. When the control signal is transmitted, the light-acceptance unit (not shown) of air conditioner 110 receives the control signal indicating the continuation of the action. Therefore, even if the control signal is received, the action is not changed in air conditioner 110.

Control circuit 420 of HDD recorder 120 determines whether or not reception circuit 410 receives the remote-control code (Step S2810). When control circuit 420 determines that reception circuit 410 receives the remote-control code (YES in Step S2810), control circuit 420 of HDD recorder 120 determines whether or not reception circuit 410 receives the remote-control code at the time the telephone call is received (Step S2820). When control circuit 420 determines that reception circuit 410 receives the remote-control code at the time the telephone call is received (YES in Step S2820), control circuit 420 performs the action at the time the telephone call is received (Step S2830). In the embodiment, for the control to HDD recorder 120 at the time the telephone call is received, it is assumed that HDD recorder 120 records a program which is being received by television 100. When the control signal is transmitted, HDD recorder 120 receives the control signal. When the control signal is received, HDD recorder 120 records the program which is being received by television 100.

In the meantime, control circuit 920 of remote controller 130 determines whether or not the telephone call is finished (Step S2730). Because the telephone call is not finished in the beginning (NO in Step S2730), the process in Step S2730 is repeatedly performed.

Then, when the telephone call is finished (YES in Step S2730), light-emitting unit 140 of remote controller 130 transmits the remote-control code indicating that the telephone call is finished (Step S2740).

Control circuit 420 of remote-control adapter 2400a attached to television 100 determines whether or not reception circuit 410 receives remote-control code (Step S2850). When control circuit 420 determines that reception circuit 410 receives remote-control code (YES in Step S2850), control circuit 420 determines whether or not reception circuit 410 receives the remote-control code at the time the telephone call is finished (Step S2860). Because the telephone call is not finished in the beginning (NO in Step S2860), the process in Step S2860 is repeatedly performed.

Then, when control circuit 420 determines that reception circuit 410 receives the remote-control code at the time the telephone call is finished (YES in Step S2860), control circuit 420 outputs the signal for transferring to the previous action of the reception of the telephone call through second transmission circuit 460 (Step S2870). Therefore, the volume of television 100 returns to the previous state of the reception of the telephone call.

Control circuit 420 of remote-control adapter 2400b attached to air conditioner 110 determines whether or not reception circuit 410 receives the remote-control code (Step S2850). When control circuit 420 determines that reception circuit 410 receives the remote-control code (YES in Step S2850), control circuit 420 determines whether or not reception circuit 410 receives the remote-control code at the time the telephone call is finished (Step S2860). Because the telephone call is not finished in the beginning (NO in Step S2860), the process in Step S2860 is repeatedly performed.

Then, when control circuit 420 determines that reception circuit 410 receives the remote-control code at the time the telephone call is finished (YES in Step S2860), control circuit 420 outputs the signal for transferring to the previous action of the reception of the telephone call through second transmission circuit 460 (Step S2870). In this case, the action is not particularly changed in air conditioner 10.

Control circuit 420 of HDD recorder 120 determines whether or not reception circuit 410 receives the remote-control code (Step S2850). When control circuit 420 determines that reception circuit 410 receives the remote-control code (YES in Step S2850), control circuit 420 determines whether or not reception circuit 410 receives the remote-control code at the time the telephone call is finished (Step S2860). Because the telephone call is not finished in the beginning (NO in Step S2860), the process in Step S2860 is repeatedly performed.

Then, when control circuit 420 determines that reception circuit 410 receives the remote-control code at the time the telephone call is finished (YES in Step S2860), control circuit 420 transfers to the previous action of the reception of the telephone call (Step S2870). In this case, HDD recorder 120 stops the recording.

Thus, the remote-control adapter of the embodiment transmits the identification information stored in the flash memory in the form of the blinking optical signal. The identification information includes the serial number of the remote-control adapter. As a result, the remote controller receiving the optical signal can function as a terminal for remotely controlling the instrument.

Then, when remote controller 130 receives the optical signal from another remote-control adapter having the similar configuration for transmitting the optical signal, remote controller 130 can authenticate another instrument to which another remote-control adapter is attached. Therefore, one remote controller 130 can function as an apparatus for controlling the plurality of instruments.

In the remote-control adapter of the embodiment, the remote controller has the broadcast command which can simultaneously control the plurality of instruments. The function corresponding to the broadcast command is previously allocated to the plurality of home electric instruments. Therefore, the home electric instruments receive the remote-control code indicating the broadcast command can concurrently perform the corresponding functions.

The remote controller of the embodiment transmits the signal in the form of the infrared ray to the remote-control adapter. The signal in the form of the infrared ray hardly reaches the plurality of rooms. Therefore, because the broadcast command is easily transmitted only to the home electric instruments installed in one room, the malfunction is hardly generated in the home electric instruments in other rooms.

The remote controller of the embodiment works with the telephone, so that the remote controller can transmit the broadcast command when the telephone call is received. This enables the home electric instruments to simultaneously recognize that telephone call is received. Therefore, the control can be performed such that the volume is turned down in the television and the program which the user is watching is recorded in the HDD recorder. Because the control in each home electric instrument is performed in parallel, it is not necessary for the user to turn down the volume of the television point by point. Because the control is performed for the extremely short time, a possibility that the calling party hangs up the telephone is decreased. Because the control signal is transmitted in the form of the infrared ray, the control is performed only in the room where the remote controller exists, and the control is not performed in other rooms. Therefore, the malfunction can effectively be prevented.

In a remote-control adapter according to a first modification of the embodiment, it may be determined in Step S2710 whether or not the off-hook signal indicating that the receiver is picked up is received. In this case, in Step S2820, control circuit 420 may determine whether or not reception circuit 410 receives the remote-control code at the time the receiver is picked up.

In a remote-control adapter according to a second modification of the embodiment, the process in Step S2870 may not be performed.

In a control system according to a third modification of the embodiment, the home electric instrument may include an electromagnetic cooker. In this case, the electromagnetic cooker can stop heating when the telephone call is received.

In a control system according to a fourth modification of the embodiment, the signal for controlling the instrument may be transmitted immediately after the broadcast command is transmitted. Therefore, the substantially same control as the broadcast command can be performed, even if the remote-control adapter is not attached to the instrument nor have the instrument the remote-control adapter function.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A control system comprising:
a remote controller; and
a plurality of remote-control adapters, wherein
said remote controller includes a communication unit performing signal communication so as to transmit a broadcast signal as a kind of control signal to said plurality of remote-control adapters until receiving an off-hook signal since receiving a ringing signal, and
said remote-control adapter includes:
a reception unit receiving said broadcast signal from the communication unit of said remote controller; and
a performing unit performing an action according to a combination of said broadcast signal and said remote-control adapter when said reception unit receives said broadcast signal.

2. A control system comprising:
a communication apparatus; and
a plurality of instruments, wherein
said communication apparatus includes a communication unit performing signal communication, and
said instrument includes:
a reception unit receiving a control signal from the communication unit of said communication apparatus, and
a performing unit performing an action according to a combination of a broadcast signal as a kind of control signal and said instrument when said reception unit receives said broadcast signal.

3. The control system according to claim 2, wherein
the communication unit of said communication apparatus performs signal communication so as to transmit said broadcast signal to said plurality of instruments when receiving a ringing signal.

4. The control system according to claim 3, wherein
said communication unit performs said signal communication so as to transmit said broadcast signal to said plurality of instruments until receiving an off-hook signal since receiving said ringing signal.

5. The control system according to claim 2, wherein
said communication apparatus further includes an operation unit accepting an operation to said communication apparatus, and
the communication unit of said communication apparatus transmits said control signal corresponding to contents of said operation to said plurality of instruments when said operation is accepted.

6. An instrument comprising:
a reception unit receiving a control signal;
a storage unit storing information indicating contents of said control signal such that at least a part of contents of a broadcast signal as a kind of said control signal overlaps one of the contents of said control signal;
a generation unit generating a control signal corresponding to the information stored in said storage unit when said reception unit receives said control signal; and
a transmission unit transmitting the control signal generated by said generation unit using an infrared ray.

7. The instrument according to claim 6, wherein
said reception unit receives said control signal through wireless communication.

8. The instrument according to claim 7, wherein
said reception unit receives said control signal through communication using the infrared ray.
